(19) United States
(12) Patent Application Publication
(10) Pub. No.: US 2015/0059430 A1
(43) Pub. Date: Mar. 5, 2015

(54) INERTIAL FORCE SENSOR

(71) Applicant: Panasonic Intellectual Property Management Co., Ltd., Osaka (JP)

(72) Inventors: Takashi Imanaka, Osaka (JP); Hiroyuki Aizawa, Osaka (JP); Takeshi Yokota, Fukui (JP)

(73) Assignee: Panasonic Intellectual Property Management Co., Ltd., Osaka (JP)

(21) Appl. No.: 14/394,871

(22) PCT Filed: Apr. 18, 2013
(86) PCT No.: PCT/JP2013/002611

§ 371 Date: Oct. 16, 2014

(30) Foreign Application Priority Data
Apr. 20, 2012 (JP) 2012-096350
Jul. 12, 2012 (JP) 2012-156237
Aug. 31, 2012 (JP) 2012-190934

(51) Int. Cl. G01P 21/00; G01P 15/12

(52) U.S. Cl. CPC G01P 21/00; G01P 15/12
USPC 73/1.38

(57) ABSTRACT

An inertial force sensor includes a fixed part, a beam connected to the fixed part, a plummet connected to another end of the beam and being displaceable due to inertial force to cause the beam to deform, a conductive part provided at the plummet, a strain-sensitive resistor provided at the beam for detecting a deformation of the first beam, first and second fault diagnostic electrodes provided at the fixed part, a first fault diagnostic wiring for connecting the first fault diagnostic electrode to the conductive part through the beam, and a second fault diagnostic wiring for connecting the second fault diagnostic electrode to the conductive part through the beam. The inertial force sensor does not continue to output an erroneous output signal when a crack occurs in the plummet, thus having high reliability.

### TECHNICAL FIELD

The present invention relates to an inertial force sensor for detecting inertial force, such as acceleration and an angular velocity, which is used in, e.g. vehicles and portable terminals.

### BACKGROUND ART

FIG. 19 is a top view of conventional inertial force sensor 501. Inertial force sensor 501 is an acceleration sensor for detecting acceleration. Frame 1 includes fixed parts 1a to 1d connected to each other to form a ring shape surrounding hollow region 2. Beams 3 to 6 each having respective one ends connected to frame 1 extend to hollow region 2. Plummet 7 extends obliquely from another end of beam 3. Plummet 8 extends obliquely from another end of beam 5. Plummet 9 is connected to another end of beam 4. Plummet 10a is connected to another end of beam 6. Strain-sensitive resistors 11 are provided on an upper surface of beam 3. Strain-sensitive resistors 13 are provided on an upper surface of beam 5. Strain-sensitive resistors 12 are provided on an upper surface of beam 4. Strain-sensitive resistors 14 are provided on an upper surface of beam 6. Strain-sensitive resistors 11 to 14 are electrically connected to each other with wirings to form a bridge circuit. In conventional inertial force sensor 501, plummets 7 to 10 are displaced in vertical directions in response to acceleration applied thereto. The displacements of the plummets changes resistances of strain-sensitive resistors 11 to 14. The acceleration is detected based on a signal output from the bridge circuit due to the change of the resistances.

A conventional inertial force sensor similar to inertial force sensor 501 is disclosed in, for example, PTL 1.

FIG. 20 is a sectional view of another conventional inertial force sensor 502. Inertial force sensor 502 is an acceleration sensor for detecting acceleration. Inertial force sensor 502 includes fixed part 201 and counter substrate 208 provided on an upper surface of fixed part 201. Fixed part 201 includes outer frame portion 203, plummet 202, and deformable portion 204 having one end connected to outer frame portion 203 and another end connected to plummet 202. Counter substrate 208 is connected to outer frame portion 203 and faces plummet 202. Inertial force sensor 502 includes self-diagnostic electrode 207 formed on an upper surface of plummet 202 and counter electrode 206 provided on a lower surface of counter substrate 208. Counter electrode 206 faces self-diagnostic electrode 207 with a predetermined air gap between counter electrode 206 faces self-diagnostic electrode 207.

When voltage Vd is applied between self-diagnostic electrode 207 and counter electrode 206 to apply electrostatic force Fd to plummet 202, plummet 202 can be displaced as if acceleration is applied to plummet 202.

It is possible to determine whether or not inertial force sensor 502 works normally.

A conventional inertial force sensor similar to inertial force sensor 502 is disclosed in, for example, PTL 2.

### CITATION LIST

### Patent Literature

PTL 1: Japanese Patent Laid-Open Publication No. 2007-85800

PTL 2: Japanese Patent Laid-Open Publication No. 5-322925

### SUMMARY

An inertial force sensor includes a fixed part, a beam connected to the fixed part, a plummet connected to another end of the beam and being displaceable due to an inertial force to cause the beam to deform, a conductive part provided at the plummet, a strain-sensitive resistor provided at the beam for detecting a deformation of the first beam, first and second fault diagnostic electrodes provided at the fixed part, a first fault diagnostic wiring connecting the first fault diagnostic electrode to the conductive part through the beam, and a second fault diagnostic wiring for connecting the second fault diagnostic electrode to the conductive part through the beam.

The inertial force sensor does not continue to output an erroneous output signal when a crack occurs in the plummet, thus having high reliability.

### BRIEF DESCRIPTION OF DRAWINGS

FIG. 1 is a top view of an inertial force sensor in accordance with Exemplary Embodiment 1.

FIG. 2 is a top view of the inertial force sensor in accordance with Embodiment 1.

FIG. 3 is a top view of the inertial force sensor in accordance with Embodiment 1.

FIG. 4A is a top view of the inertial force sensor in accordance with Embodiment 1.

FIG. 4B is a schematic diagram of a detection circuit of the inertial force sensor in accordance with Embodiment 1.

FIG. 4C is a schematic diagram of the detection circuit of the inertial force sensor in accordance with Embodiment 1.

FIG. 4D is a schematic diagram of the detection circuit of the inertial force sensor in accordance with Embodiment 1.

FIG. 5 is a circuit diagram of the inertial force sensor in accordance with Embodiment 1.

FIG. 6 shows an output voltage of a fault diagnosis circuit of the inertial force sensor in accordance with Embodiment 1.

FIG. 7 is a top view of an inertial force sensor in accordance with Exemplary Embodiment 2.

FIG. 8 is a circuit diagram of the inertial force sensor in accordance with Embodiment 2.

FIG. 9 is a top view of an inertial force sensor in accordance with Exemplary Embodiment 3.

FIG. 10 is a sectional view of the inertial force sensor at line 10-10 shown in FIG. 10.

FIG. 11A is a schematic view of the inertial force sensor in accordance with Embodiment 3.

FIG. 11B is a schematic view of the inertial force sensor in accordance with Embodiment 3.

FIG. 12 is a circuit diagram of the inertial force sensor in accordance with Embodiment 3.

FIG. 13 is a top view of a Comparative Example of an inertial force sensor.

FIG. 14 is a top view of an inertial force sensor in accordance with Exemplary Embodiment 4.

FIG. 15 is a sectional view of the inertial force sensor at line 15-15 shown in FIG. 14.

FIG. 16A is a top view of the inertial force sensor in accordance with Embodiment 4.

FIG. 16B is a circuit diagram of the inertial force sensor in accordance with Embodiment 4.

FIG. 16C is a circuit diagram of the inertial force sensor in accordance with Embodiment 4.

FIG. 16D is a circuit diagram of the inertial force sensor in accordance with Embodiment 4.

FIG. 17A is a top view of the inertial force sensor in accordance with Embodiment 4 for illustrating an operation of the inertial force sensor.

FIG. 17B is a circuit diagram of the inertial force sensor in accordance with Embodiment 4 for illustrating an operation of the inertial force sensor.

FIG. 17C is a circuit diagram of the inertial force sensor in accordance with Embodiment 4 for illustrating an operation of the inertial force sensor.

FIG. 17D is a top view of the inertial force sensor in accordance with Embodiment 4 for illustrating an operation of the inertial force sensor.

FIG. 17E is a top view of the inertial force sensor in accordance with Embodiment 4 for illustrating an operation of the inertial force sensor.

FIG. 18 is a top view of another inertial force sensor in accordance with Embodiment 4.

FIG. 19 is a sectional view of a conventional inertial force sensor.

FIG. 20 is a sectional view of another conventional inertial force sensor.

### DETAIL DESCRIPTION OF PREFERRED EMBODIMENTS

### Exemplary Embodiment 1

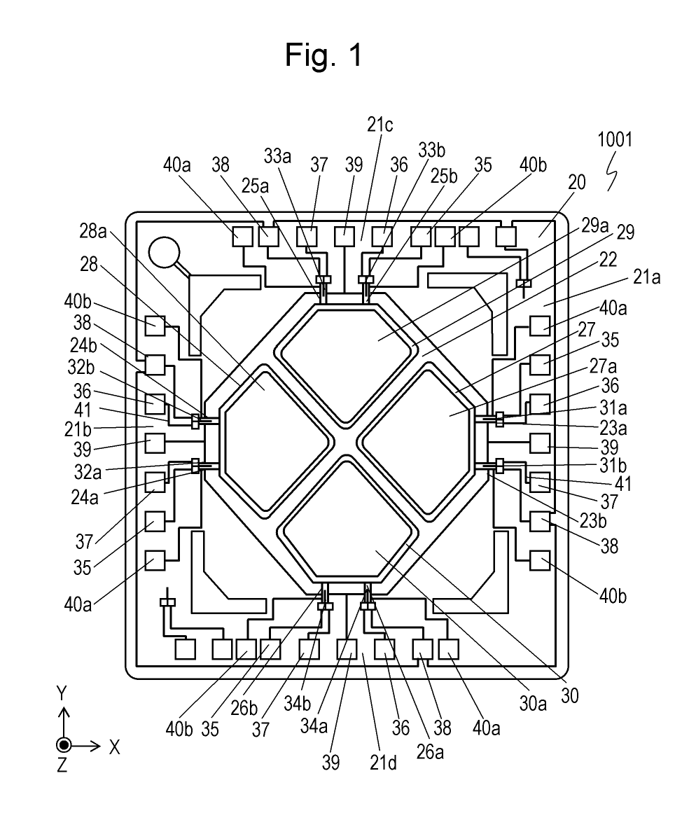

FIG. 1 is a top view of inertial force sensor 1001 in accordance with Exemplary Embodiment 1. Inertial force sensor 1001 is an acceleration sensor for detecting acceleration, an inertial force, applied thereto. Inertial force sensor 1001 includes frame 20, beams 23a to 26a and 23b to 26b connected to frame 20, and plummets 27 to 30 connected to beams 23a to 26a and 23b to 26b and coupled to frame 20 through beams 23a to 26a and 23b to 26b. Frame 20 includes fixed parts 21a to 21d connected to each other to form a rectangular ring shape surrounding hollow region 2. Fixed parts 21a and 21b are sides of the rectangular ring shape of frame 20 facing each other while fixed parts 21c and 21d are other sides of the rectangular ring shape of frame 20 facing each other. Beams 23a to 26a and 23b to 26b extend from frame 20 to hollow region 22. One end of each of beams 23a and 23b is connected to fixed part 21a of frame 20. One end of each of beams 24a and 24b is connected to fixed part 21b of frame 20. One end of each of beams 25a and 25b is connected to fixed part 21c of frame 20. One end of each of beams 26a and 26b is connected to fixed part 21d of frame 20.

Plummet 27 is connected to another end of each of beams 23a and 23b. Plummet 28 is connected to another end of each of beams 24a and 24b. Plummet 29 is connected to another end of each of beams 25a and 25b. Plummet 30 is connected to another end of each of beams 26a and 26b.

Plummet 27 is displaced due to the acceleration, the inertial force, applied thereto to cause beams 23a and 23b to deform. Plummet 28 is displaced due to the acceleration to cause beams 24a and 24b to deform. Plummet 29 is displaced due to the acceleration to cause beams 25a and 25b to deform. Plummet 30 is displaced due to the acceleration to cause beams 26a and 26b to deform. Strain-sensitive resistors 31a and 31b are provided on upper surfaces of beams 23a and 23b, respectively. Strain-sensitive resistors 33a and 33b are provided on upper surfaces of beams 25a and 25b, respectively. Strain-sensitive resistors 32a and 32b are provided on upper surfaces of beams 24a and 24b, respectively. Strain-sensitive resistors 34a and 34b are provided on upper surfaces of beams 26a and 26b, respectively. Beams 23a and 23b extend in a direction of an X-axis. Plummet 27 is located in a negative direction of the X-axis from fixed part 21a while plummet 28 is located in a positive direction of the X-axis from fixed part 21b. Beams 25a and 25b extend in a direction of a Y-axis perpendicular to the X-axis. Plummet 29 is located in a negative direction of the Y-axis from fixed part 21c while plummet 30 is located in a positive direction of the Y-axis from fixed part 21d.

Plummet 27 faces plummet 28, and plummet 29 faces plummet 30. Conductive parts 27a, 28a, 29a, and 30a are provided on plummets 27, 28, 29, and 30, respectively. In this configuration, plummet 27 is supported by beams 23a and 23b from only one direction (the negative direction of the X-axis). Plummet 28 is supported by beams 24a and 24b from only one direction (the positive direction of the X-axis). Plummet 29 is supported by beams 25a and 25b from only one direction (the negative direction of the Y-axis). Plummet 30 is supported by beams 26a and 26b from only one direction (the positive direction of the Y-axis). This configuration prevents transition of beams 23a to 26a and 23b to 26b to different buckling modes by the displacement of plummets 27 to 30, hence suppressing variation of sensitivity of inertial force sensor 1001 and a change of the sensitivity with time. Power-supply electrode 35 for applying a voltage, output electrodes 36 and 37, and GND electrode 38 to be grounded are provided on each of fixed parts 21a to 21d. Power-supply electrode 35, output electrodes 36 and 37, and GND electrode 38 to be grounded are electrically connected to strain-sensitive resistors 31a to 34a and 31b to 34b with wirings 41 as to constitute a bridge circuit.

Fault diagnostic electrode 39 for applying a voltage for fault diagnosis and a pair of fault diagnostic electrodes 40a and 40b are provided on each of fixed parts 21a to 21d.

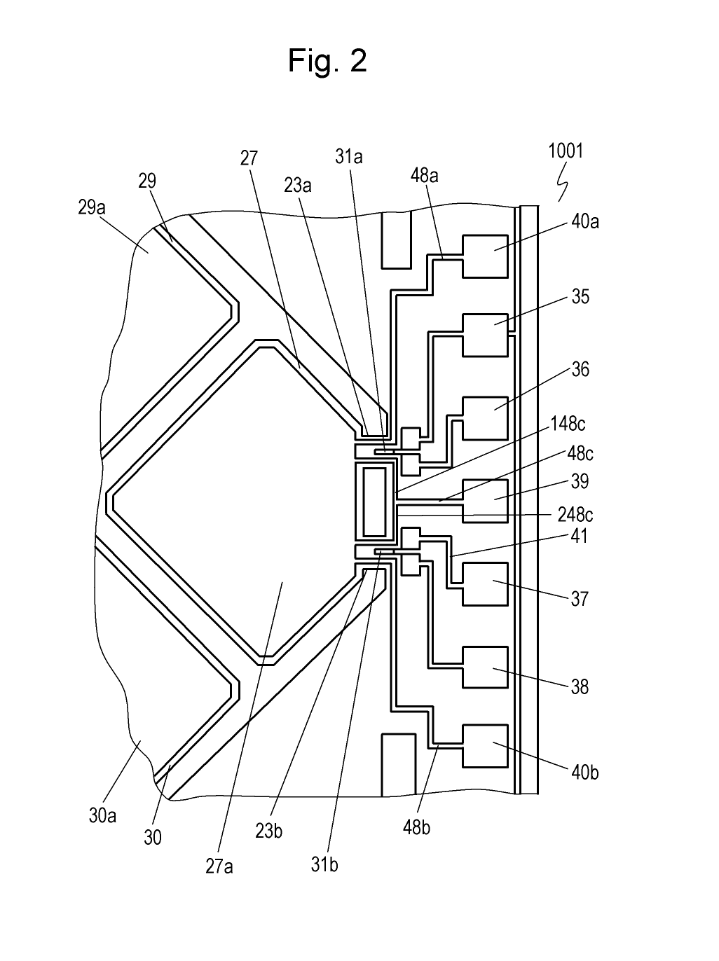

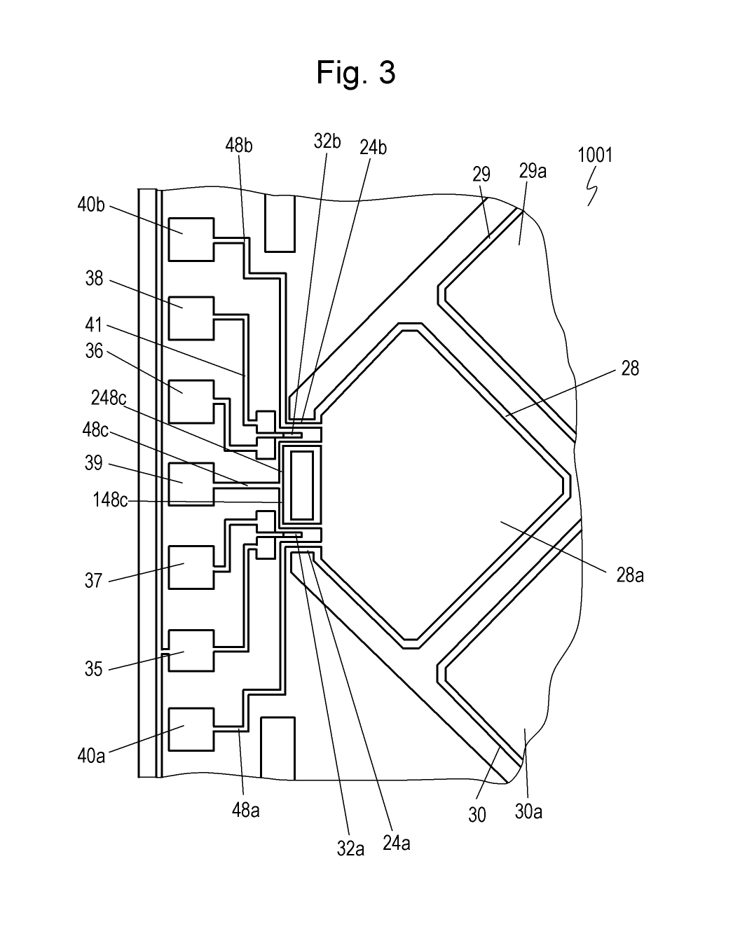

FIGS. 2 and 3 are enlarged top views of inertial force sensor 1001 for illustrating a peripheral portion of fixed part 21a and a peripheral portion of fixed part 21b, respectively. In the peripheral portion of fixed part 21a shown in FIG. 2, fault diagnostic wiring 48c extends from fault diagnostic electrode 39 provided at fixed part 21a and is branched into branch lines 148c and 248c. Branch lines 148c and 248c are connected to conductive part 27a through upper surfaces of beams 23a and 23b, respectively. Thus, fault diagnostic electrode 39 provided at fixed part 21a is connected to conductive part 27a via fault diagnostic wiring 48c. Fault diagnostic wiring 48a extends from fault diagnostic electrode 40a provided at fixed part 21a through the upper surface of beam 23a to be connected to conductive part 27a. Thus, fault diagnostic electrode 40a provided at fixed part 21a is connected to conductive part 27a via fault diagnostic wiring 48a. Fault diagnostic wiring 48b extends from fault diagnostic electrode 40b provided at fixed part 21a through the upper surface of beam 23b to be connected to conductive part 27a. Thus, fault diagnostic electrode 40b provided to fixed part 21a is connected to conductive part 27a via fault diagnostic wiring 48b. In the peripheral portion of fixed part 21b shown in FIG. 3, fault diagnostic wiring 48c extends from fault diagnostic electrode 39 provided at fixed part 21b and is branched into branch lines 148c and 248c. Branch lines 148c and 248c are connected to conductive part 28a through upper surfaces of beams 24a and 24b, respectively. Thus, fault diagnostic electrode 39 provided at fixed part 21b is connected to conductive part 28a via fault diagnostic wiring 48c. Fault diagnostic wiring 48a extends from fault diagnostic electrode 40a provided to fixed part 21b through the upper surface of beam 24a to be connected to conductive part 28a. Thus, fault diagnostic electrode 40a provided at fixed part 21b is connected to conductive part 28a via fault diagnostic wiring 48a. Fault diagnostic wiring 48b extends from fault diagnostic electrode 40b provided at fixed part 21b through the upper surface of beam 24b to be connected to conductive part 28a. Thus, fault diagnostic electrode 40b provided to fixed part 21b is connected to conductive part 28a via fault diagnostic wiring 48b.

Similar to the peripheral portions of fixed parts 21a and 21b, in the peripheral portion of fixed part 21c, fault diagnostic wiring 48c extends from fault diagnostic electrode 39 provided to fixed part 21c and is branched into branch lines 148c and 248c. Branch lines 148c and 248c are connected to conductive part 29a through upper surfaces of beams 25a and 25b, respectively. Thus, fault diagnostic electrode 39 provided to fixed part 21c is coupled to conductive part 29a via fault diagnostic wiring 48c. Fault diagnostic wiring 48a extends from fault diagnostic electrode 40a provided at fixed part 21c through the upper surface of beam 25a to be connected to conductive part 29a. Thus, fault diagnostic electrode 40a provided at fixed part 21c is connected to conductive part 29a via fault diagnostic wiring 48a. Fault diagnostic wiring 48b extends from fault diagnostic electrode 40b provided at fixed part 21c through the upper surface of beam 25b to be connected to conductive part 29a. Thus, fault diagnostic electrode 40b provided at fixed part 21c is connected to conductive part 29a via fault diagnostic wiring 48b. In the peripheral portion of fixed part 21d, fault diagnostic wiring 48c extends from fault diagnostic electrode 39 provided at fixed part 21d and is branched into branch lines 148c and 248c. Branch lines 148c and 248c extend through upper surfaces of beams 26a and 26b, respectively, to be connected to conductive part 30a. Thus, fault diagnostic electrode 39 provided at fixed part 21d is connected to conductive part 30a via fault diagnostic wiring 48c. Fault diagnostic wiring 48a extends from fault diagnostic electrode 40a provided at fixed part 21d through the upper surface of beam 26a to be connected to conductive part 30a. Thus, fault diagnostic electrode 40a provided to fixed part 21d is connected to conductive part 30a via fault diagnostic wiring 48a. Fault diagnostic wiring 48b extends from fault diagnostic electrode 40b provided at fixed part 21d through the upper surface of beam 26b to be connected to conductive part 30a. Thus, fault diagnostic electrode 40b provided at fixed part 21d is connected to conductive part 30a via fault diagnostic wiring 48b.

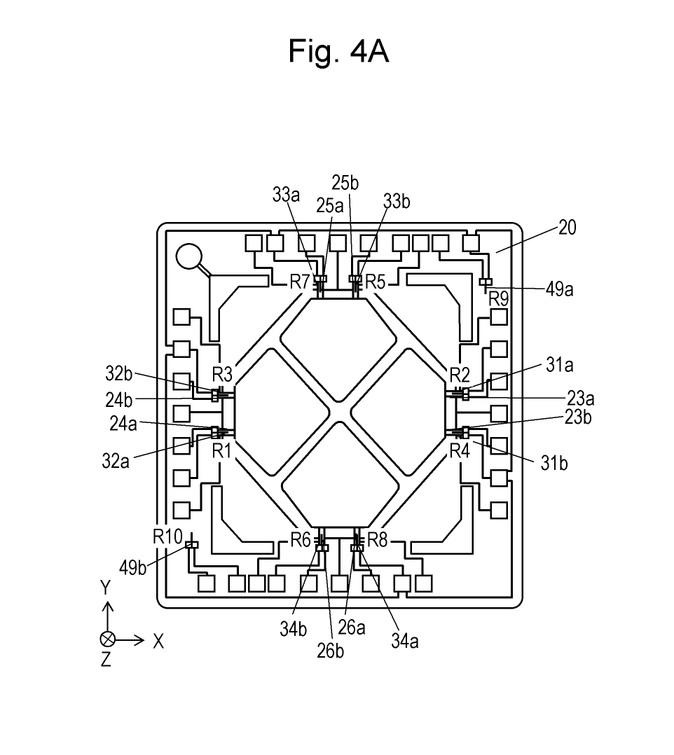

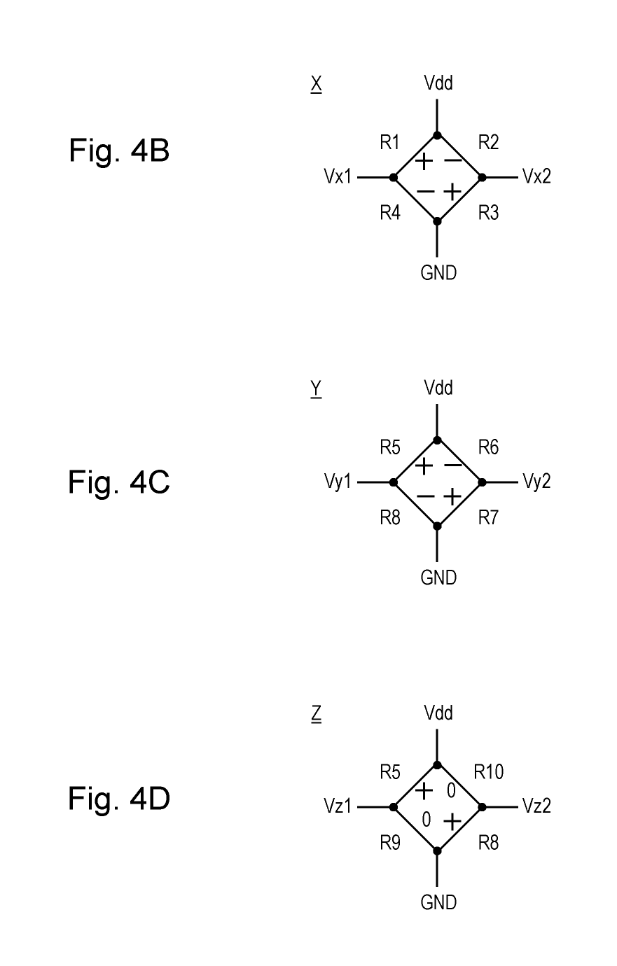

FIG. 4A is a top view of inertial force sensor 1001. Strain-sensitive resistors 31a and 31b provided at beams 23a and 23b constitute resistors R2 and R4, respectively. Strain-sensitive resistors 32a and 32b provided at beams 24a and 24b constitute resistors R1 and R3, respectively. Strain-sensitive resistors 33a and 33b provided at beams 25a and 25b constitute resistors R7 and R5, respectively. Strain-sensitive resistors 34a and 34b provided at beams 26a and 26b constitute resistors R8 and R6, respectively. Strain-sensitive resistors 49a and 49b provided at frame 20 constitutes resistors R9 and R10, respectively.

FIG. 4B is a schematic diagram of a detection circuit of inertial force sensor 1001 for detecting acceleration in a direction of the X-axis. As shown in FIG. 4B, resistors R1, R2, R3, and R4 are connected to constitute a bridge circuit. A voltage is applied between a pair of nodes Vdd and GND opposite to each other while a voltage between another pair of nodes Vx1 and Vx2, thereby detecting the acceleration in direction of the X-axis.

FIG. 4C is a schematic diagram of a detection circuit of inertial force sensor 1001 for detecting acceleration in a direction of the Y-axis. As shown in FIG. 4C, resistors R5, R6, R7, and R8 are connected to form a bridge circuit.

A voltage is applied between a pair of nodes Vdd and GND opposite to each other while a voltage between another pair of nodes Vy1 and Vy2 is detected, thereby, detecting the acceleration in the direction of the Y-axis.

FIG. 4D is a schematic diagram of a detection circuit of inertial force sensor 1001 for detecting acceleration in a direction of a Z-axis perpendicular to the X-axis and the Y-axis. As shown in FIG. 4D, resistors R5, R10, R8, and R9 are connected to form a bridge circuit. A voltage is applied between a pair of nodes Vdd and GND opposite to each other while a voltage between another pair of nodes Vz1 and Vz2 is detected, thereby, detecting the acceleration in the direction of the Z-axis direction.

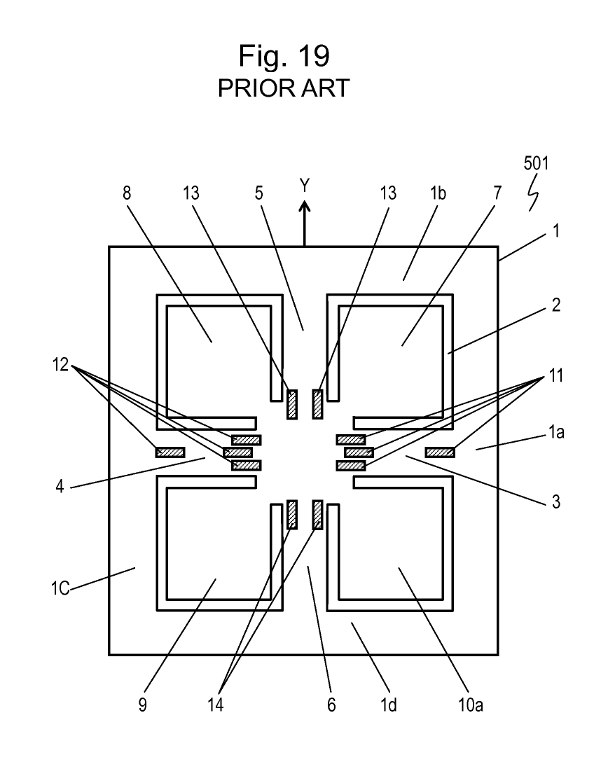

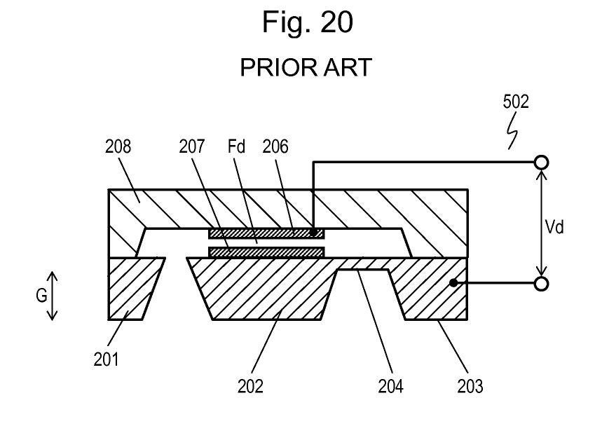

Upon being used for a long time, conventional inertial force sensor 501 shown in FIG. 19 may have a crack in bases of plummets 7 to 10. Such crack may change an amount of a displacement in the vertical direction of plummets 7 to 10, and cause resistances of strain-sensitive resistors 11 to 14 to fluctuate. Therefore, a signal output from the bridge circuit composed of strain-sensitive resistors 11 to 14 may not necessarily reflect the acceleration, thus preventing the acceleration from being detected accurately.

In inertial force sensor 1001 in accordance with Embodiment, if excessive acceleration is applied repetitively during the usage of inertial force sensor 1001 for a long time, the amounts of displacements of plummets 27 to 30 increases repetitively. This may cause beams 23a to 26a and 23b to 26b to fatigue, and produce cracks in the beams. Inertial force sensor 1001 in accordance with Embodiment 1 can detect a fault in which a crack is produced in a beam out of beams 23a to 26a and 23b to 26b.

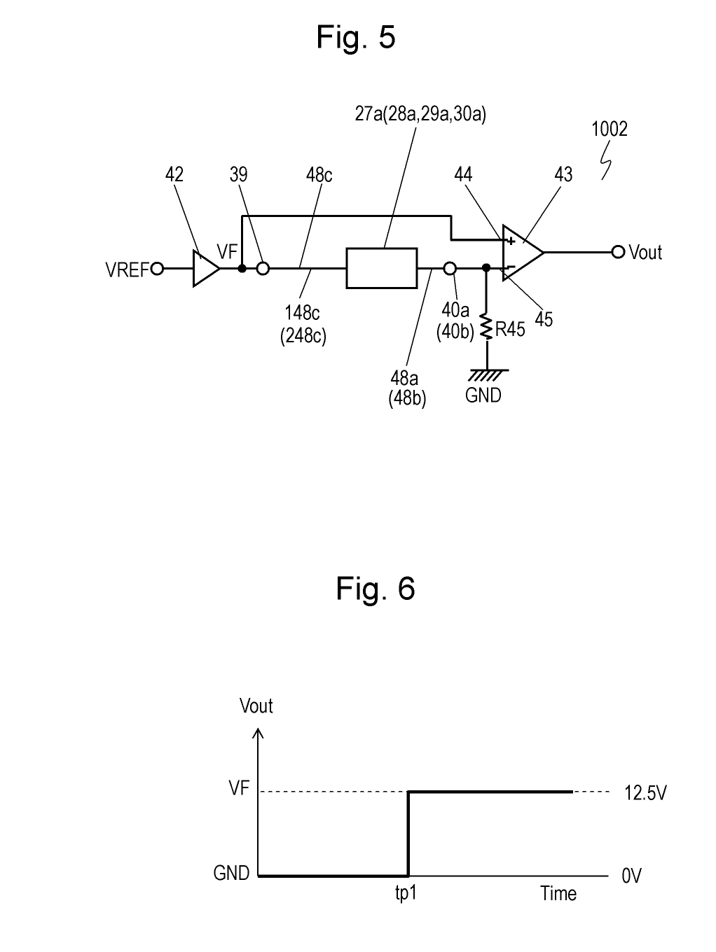

FIG. 5 is a circuit diagram of fault diagnosis circuit 1002 of inertial force sensor 1001 for detecting the fault. Input voltage VF for fault diagnosis which has been amplified by amplifier 42 of fault diagnosis circuit 1002 is applied to fault diagnostic electrode 39 provided at fixed part 21a, and is input into non-inverting input terminal 44 of comparator 43. Input voltage VF applied to fault diagnostic electrode 39 is applied to inverting input terminal 45 of comparator 43 via fault diagnostic wiring 48c (branch line 148c), conductive part 27a, fault diagnostic wiring 48a, and fault diagnostic electrode 40a. Fault diagnostic electrode 40a is configured to be connected to inverting input terminal 45 of comparator 43, and grounded via grounding resistor R45.

Similarly, input voltage VF for fault diagnosis which has been amplified by amplifier 42 of another fault diagnosis circuit 1002 is applied to fault diagnostic electrode 39 provided at fixed part 21a, and is input into non-inverting input terminal 44 of comparator 43. Input voltage VF applied to fault diagnostic electrode 39 is applied to inverting input terminal 45 of comparator 43 via fault diagnostic wiring 48c (branch line 248c), conductive part 27a, fault diagnostic wiring 48b, and fault diagnostic electrode 40b. Fault diagnostic electrode 40b is configured to be connected to inverting input terminal 45 of comparator 43 and grounded via grounding resistor R45.

Similarly, input voltage VF for fault diagnosis, which is amplified by amplifier 42 of still another fault diagnosis circuit 1002, is applied to fault diagnostic electrode 39 provided to fixed part 21b, and further input into non-inverting input terminal 44 of comparator 43. Input voltage VF applied to fault diagnostic electrode 39 is applied to inverting input terminal 45 in comparator 43 through fault diagnostic wiring 48c (branch line 148c), conductive part 28a, fault diagnostic wiring 48a and fault diagnostic electrode 40a. Fault diagnostic electrode 40a is configured in such a manner that it is coupled to inverting input terminal 45 of comparator 43 and grounded through grounding resistor R45.

Similarly, input voltage VF for fault diagnosis which has been amplified by amplifier 42 of still another fault diagnosis circuit 1002 is applied to fault diagnostic electrode 39 provided at fixed part 21b, and input into non-inverting input terminal 44 of comparator 43. Input voltage VF applied to fault diagnostic electrode 39 is applied to inverting input terminal 45 in comparator 43 via fault diagnostic wiring 48c (branch line 248c), conductive part 28a, fault diagnostic wiring 48b, and fault diagnostic electrode 40b. Fault diagnostic electrode 40b is configured to be connected to inverting input terminal 45 of comparator 43 and grounded via grounding resistor R45.

Similarly, input voltage VF for fault diagnosis which has been amplified by amplifier 42 of further fault diagnosis circuit 1002 is applied to fault diagnostic electrode 39 provided at fixed part 21c, and input into non-inverting input terminal 44 of comparator 43. Input voltage VF applied to fault diagnostic electrode 39 is applied to inverting input terminal 45 of comparator 43 via fault diagnostic wiring 48c (branch line 148c), conductive part 29a, fault diagnostic wiring 48a, and fault diagnostic electrode 40a. Fault diagnostic electrode 40a is configured to be connected to inverting input terminal 45 of comparator 43 and grounded via grounding resistor R45.

Similarly, input voltage VF for fault diagnosis which has been amplified by amplifier 42 of further fault diagnosis circuit 1002 is applied to fault diagnostic electrode 39 provided at fixed part 21c, and input into non-inverting input terminal 44 of comparator 43. Input voltage VF applied to fault diagnostic electrode 39 is applied to inverting input terminal 45 of comparator 43 via fault diagnostic wiring 48c (branch line 248c), conductive part 29a, fault diagnostic wiring 48b, and fault diagnostic electrode 40b. Fault diagnostic electrode 40b is configured to be connected to inverting input terminal 45 of comparator 43 and grounded via grounding resistor R45.

Similarly, input voltage VF for fault diagnosis which has been amplified by amplifier 42 of further fault diagnosis circuit 1002 is applied to fault diagnostic electrode 39 provided at fixed part 21d, and input into non-inverting input terminal 44 of comparator 43. Input voltage VF applied to fault diagnostic electrode 39 is applied to inverting input terminal 45 of comparator 43 via fault diagnostic wiring 48c (branch line 148c), conductive part 30a, fault diagnostic wiring 48a, and fault diagnostic electrode 40a. Fault diagnostic electrode 40a is configured to be connected to inverting input terminal 45 of comparator 43 and grounded via grounding resistor R45.

Similarly, input voltage VF for fault diagnosis which has been amplified by amplifier 42 of further fault diagnosis circuit 1002 is applied to fault diagnostic electrode 39 provided at fixed part 21d, and input into non-inverting input terminal 44 of comparator 43. Input voltage VF applied to fault diagnostic electrode 39 is applied to inverting input terminal 45 of comparator 43 via fault diagnostic wiring 48c (branch line 248c), conductive part 30a, fault diagnostic wiring 48b, and fault diagnostic electrode 40b. Fault diagnostic electrode 40b is configured to be connected to inverting input terminal 45 of comparator 43 and grounded via grounding resistor R45.

FIG. 6 shows output voltage Vout of comparator 43 of fault diagnosis circuit 1002 connected to fault diagnostic electrodes 39 and 40a provided at fixed part 21a of inertial force sensor 1001. In FIG. 6, the vertical axis represents output voltage Vout of comparator 43, and the horizontal axis represents time. As shown in FIG. 6, a crack does not occur in beam 23a until time point tp1, hence allowing inertial force sensor 1001 to detect acceleration normally. In this normal use, since voltage VF is applied to both fault diagnostic electrodes 39 and 40a, comparator 43 outputs a voltage of 0V. When a crack occurs in beam 23a at time point tp1, at least one of fault diagnostic wirings 48a and 48c (branch lines 148c) is disconnected and opens. Then, voltage VF is input into non-inverting input terminal 44 of comparator 43 while the non-inverting input terminal is grounded via grounding resistor R45 to have a voltage of OV applied thereto, hence causing comparator 43 to output voltage VF. According to Embodiment 1, voltage VF is 12.5 V. Thus, output voltage Vout of fault diagnosis circuit 1002 connected to fault diagnostic electrodes 39 and 40a provided at fixed part 21a allows occurrence of a crack in beam 23a to be detected. Similarly, output voltage Vout of fault diagnosis circuit 1002 connected to fault diagnostic electrodes 39 and 40b provided at fixed part 21a allows occurrence of a crack in beam 23b to be detected.

Similarly, output voltage Vout of fault diagnosis circuit 1002 connected to fault diagnostic electrodes 39 and 40a provided at fixed part 21b allows occurrence of a crack in beam 24a to be detected. Similarly, output voltage Vout of fault diagnosis circuit 1002 connected to fault diagnostic electrodes 39 and 40b provided at fixed part 21b allows occurrence of a crack in beam 24b to be detected.

Similarly, output voltage Vout of fault diagnosis circuit 1002 connected to fault diagnostic electrodes 39 and 40a provided at fixed part 21c allows occurrence of a crack in beam 25a to be detected. Similarly, output voltage Vout of fault diagnosis circuit 1002 connected to fault diagnostic electrodes 39 and 40b provided at fixed part 21c allows occurrence of a crack in beam 24b to be detected.

Similarly, output voltage Vout of fault diagnosis circuit 1002 connected to fault diagnostic electrodes 39 and 40a provided at fixed part 21d allows occurrence of a crack in beam 26a to be detected. Similarly, output voltage Vout of fault diagnosis circuit 1002 connected to fault diagnostic electrodes 39 and 40b provided at fixed part 21d allows occurrence of a crack in beam 26b to be detected.

### Exemplary Embodiment 2

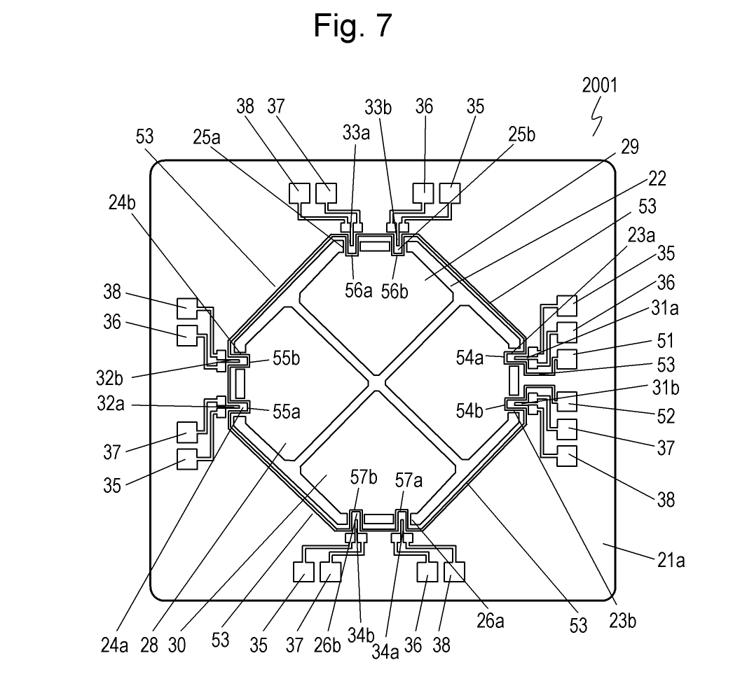

FIG. 7 is a top view of inertial force sensor 2001 in accordance with Exemplary Embodiment 2. Inertial force sensor 2001 is an acceleration sensor for detecting acceleration, an inertial force, applied thereto. In FIG. 7, components identical to those of inertial force sensor 1001 in accordance with Embodiment 1 shown in FIG. 1 are denoted by the same reference numerals.

Inertial force sensor 2001 includes fault diagnostic electrodes 51 and 52 provided only at fixed part 21a, instead of four fault diagnostic electrodes 39, four fault diagnostic electrodes 40a, and four fault diagnostic electrodes 40b of inertial force sensor 1001 in accordance with Embodiment 1 shown in FIG. 1. A fault diagnostic electrode is not provided at each of fixed parts 2 lb to 21c. Inertial force sensor 2001 includes conductive parts 54a and 54b provided on an upper surface of plummet 27 instead of conductive part 27a, includes conductive parts 55a and 55b provided on an upper surface of plummet 28 instead of conductive part 28a, includes conductive parts 56a and 56b provided on an upper surface of plummet 29 instead of conductive part 29a, and includes conductive parts 57a and 57b provided on an upper surface of plummet 30 instead of conductive part 30a. Inertial force sensor 2001 includes plural fault diagnostic wirings 53 instead of fault diagnostic wirings 48a to 48c. Fault diagnostic wirings 53 extends through 57b via beams 23a to 26a and 23b to 26b to electrically connect in series from fault diagnostic electrode 51 to fault diagnostic electrode 52 via conductive parts 54a to 57a and 54b.

Inertial force sensor 2001 can detect acceleration in directions of the X-axis, the Y-axis, and the Z-axis similarly to inertial force sensor 1001 in accordance with Embodiment 1.

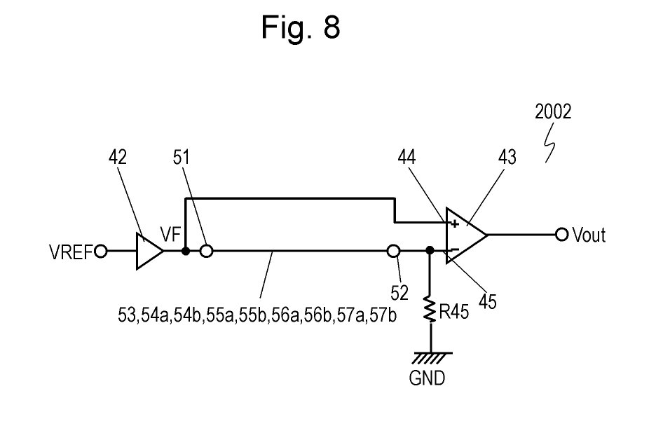

FIG. 8 is a circuit diagram of fault diagnosis circuit 2002 of inertial force sensor 2001. In FIG. 8, components identical to those of inertial force sensor 1002 shown in FIG. 5 are denoted by the same reference numerals. In fault diagnosis circuit 2002, fault diagnostic electrode 52 is connected to inverting input terminal 45 of comparator 43. Input voltage VF is applied to fault diagnostic electrode 51, and to inverting input terminal 45 of comparator 43 via fault diagnostic wiring 53, conductive parts 54a to 57a and 54b to 57b, and fault diagnostic electrode 52. In fault diagnosis circuit 2002, similarly to fault diagnosis circuit 1002 in accordance with Embodiment 1 shown in FIG. 6, a crack does not occur in any of beams 23a to 26a and 23b to 26b until time point tp1, and allows inertial force sensor 2001 to normally detect the acceleration. In this normal usage, voltage VF is applied to both fault diagnostic electrodes 51 and 52, and allows comparator 43 to output a voltage of OV. When a crack occurs in at least one of beams 23a to 26a and 23b to 26b, fault diagnostic wiring 53 is disconnected and open. Then, while voltage VF is input into non-inverting input terminal 44 of comparator 43, the non-inverting input terminal is grounded via grounding resistor R45 to have a voltage of OV applied, hence causing comparator 43 to output voltage VF. According to Embodiment 1, voltage VF is 12.5 V. Thus, output voltage Vout of fault diagnosis circuit 1002 allows occurrence of a crack in beams 23a to 26a and 23b to 26b to be detected.

### Exemplary Embodiment 3

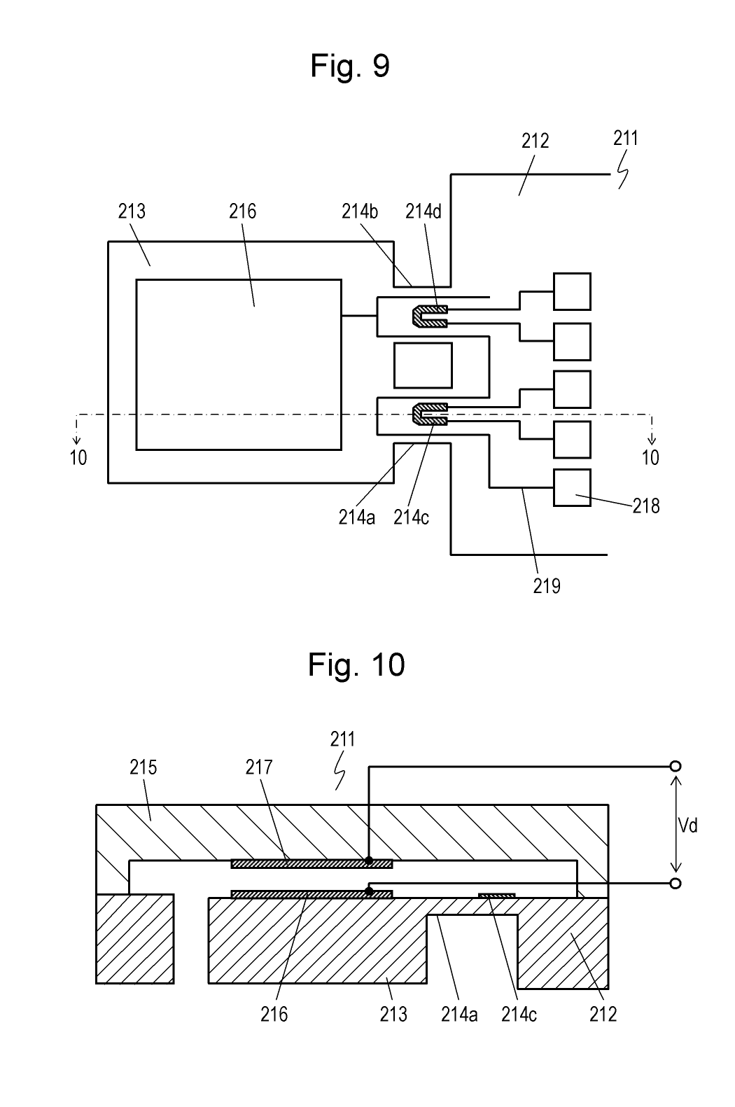

FIG. 9 is a top view of inertial force sensor 211 in accordance with

Exemplary Embodiment 3. FIG. 10 is a sectional view of inertial force sensor 211 at line 10-10 shown in FIG. 9. Inertial force sensor 211 is an acceleration sensor for detecting acceleration, an inertial force, applied thereto.

Inertial force sensor 211 includes fixed part 212, plummet 213, beams 214a and 214b having respective one ends connected to fixed part 212, counter substrate 215 connected to fixed part 212 such that counter substrate 215 faces plummet 213, plummet-displacement electrode 216 provided on an upper surface of plummet 213, counter electrode 217 provided on a lower surface of counter substrate 215, fault diagnostic electrode 218 provided at fixed part 212, and fault diagnostic wiring 219 for electrically connecting fault diagnostic electrode 218 to plummet-displacement electrode 216. Respective another ends of beams 214a and 214b are connected to plummet 213. The lower surface of counter substrate 215 faces the upper surface of plummet 213. Counter electrode 217 faces plummet-displacement electrode 216. Detection unit 214c is provided on beam 214a while detection unit 214d is provided on beam 214b. Fault diagnostic wiring 219 extends through beams 214a and 214b to be connected to fault diagnostic electrode 218 is connected to plummet-displacement electrode 216.

In this configuration, voltage Vd is applied between plummet-displacement electrode 216 and counter electrode 217 to apply an electrostatic force to plummet 213, and displaces plummet 213 as if acceleration is applied to plummet 213, thus providing a self-diagnostic function for determining whether inertial force sensor 211 normally operates or not.

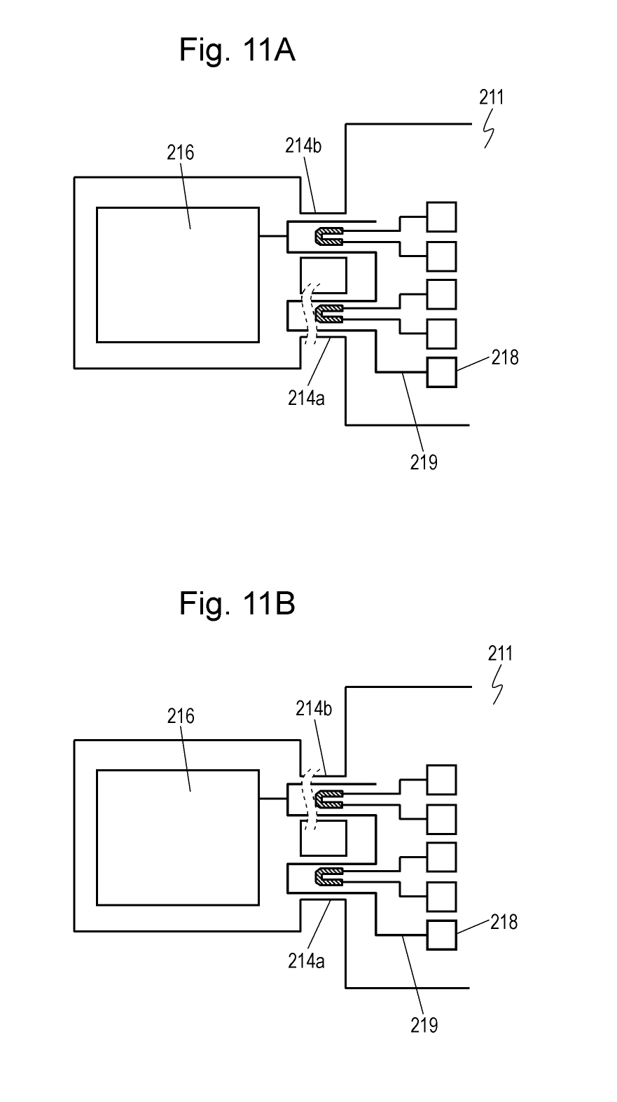

FIG. 11A is a schematic view of inertial force sensor 211 having beam 214b not broken but having beam 214a broken. FIG. 11B is a schematic view of inertial force sensor 211 having beam 214a not broken but having beam 214b broken. As shown in FIG. 11A, when beam 214a is broken, fault diagnostic wiring 219 is disconnected at beam 214a. As shown in FIG. 11B, when beam 214b is broken, fault diagnostic wiring 219 is disconnected at beam 214b. Thus, when any one of beams 214a and 214b is broken, fault diagnostic wiring 219 is disconnected, and fault diagnostic electrode 218 is electrically disconnected from plummet-displacement electrode 216 not. Therefore, even when voltage Vd is applied to fault diagnostic electrode 218, voltage Vd is not applied between plummet-displacement electrode 216 and counter electrode 217, and does not displace plummet 213. Therefore, it can be determined that inertial force sensor 211 is in a fault state.

A configuration of inertial force sensor 211 will be detailed below. Fixed part 212, plummet 213, beams 214a and 214b, and counter substrate 215 may be made of, e.g. silicon, molten quartz, or alumina. They are preferably made of silicon to provide inertial force sensor 211 with a small size by using a micromachining technology.

Fixed part 212 may adhere to counter substrate 215 with, e.g. adhesive, metal junction, ambient temperature junction, of anode junction. The adhesives may be, e.g. epoxy resin or silicone resin. The adhesive made of silicone resin can reduce a stress generated by hardening of the adhesive. Detection units 214c and 214d can utilize, e.g. a strain resistance method or a capacitance method. In the case that piezoelectric resistors are used as strain-sensitive resistors for detection units 214c and 214d, the sensitivity of inertial force sensor 211 can be improved. Furthermore, as the strain resistance method, when a thin film resistance method using an oxide film strain-sensitive resistor is used for detection units 214c and 214d, temperature characteristics of inertial force sensor 211 can be improved.

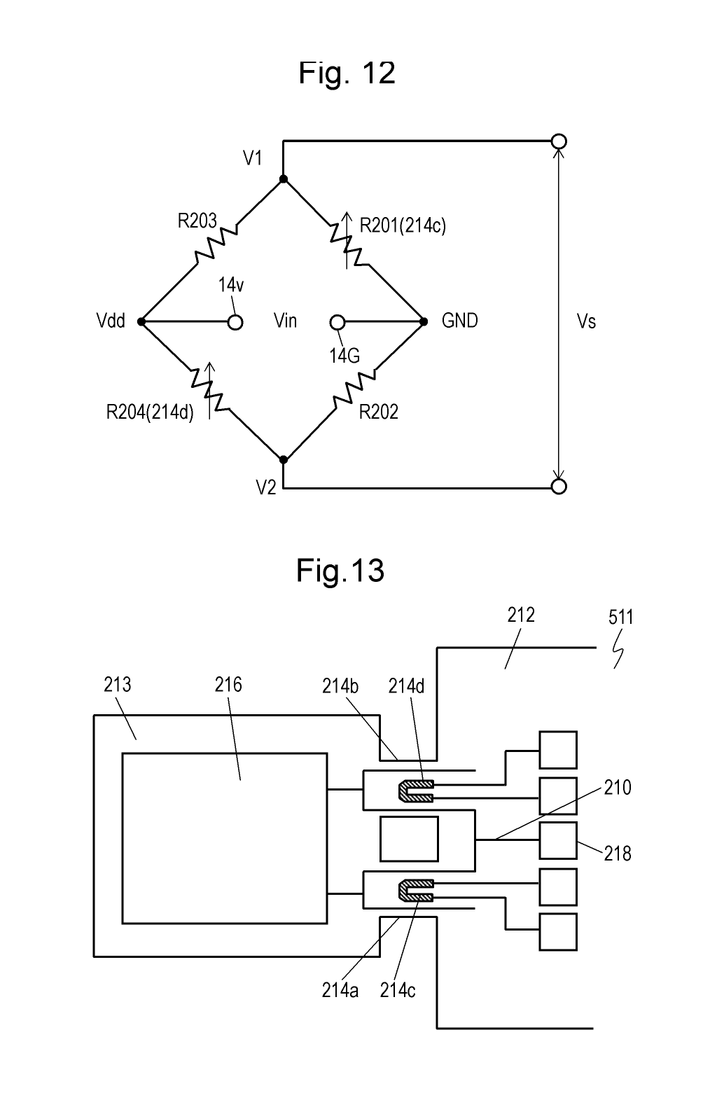

FIG. 12 is a circuit diagram of inertial force sensor 211 when detection units 214c and 214d use a strain resistance method. Strain-sensitive resistor R201 corresponds to detection unit 214c. Strain-sensitive resistor R204 corresponds to detection unit 214d. Strain-sensitive resistors R202 and R203 are reference resistors provided at fixed part 212. As shown in FIG. 12, strain-sensitive resistors R201, R202, R203, and R204 are connected to form a bridge circuit. A voltage is applied between a pair of nodes Vdd and GND opposite to each other while voltage Vs between another pair of nodes V201 and V202 is detected, thereby detecting the acceleration applied to inertial force sensor 211.

The self-diagnostic function of inertial force sensor 211 will be described with reference to FIGS. 10 and 12. To perform the self-diagnosis, voltage Vd is applied between plummet-displacement electrode 216 and counter electrode 217, as shown in FIG. 10. According to Embodiment 3, voltage Vd is about 12V. Thus, an electrostatic force is generated between plummet-displacement electrode 216 and counter electrode 217, and displaces plummet 213 such that counter substrate 215 attracts plummet 213. The displacement of plummet 213 decreases resistances of strain-sensitive resistor R201 corresponding to detection unit 214c and strain-sensitive resistor R204 corresponding to detection unit 214d. This increases output voltage Vs of the bridge circuit, and it can be determined that inertial force sensor 211 normally operates.

FIG. 13 is a top view of fixed part 212 of a Comparative Example of inertial force sensor 511. In FIG. 13, components identical to those of inertial force sensor 211 according to Embodiment 3 shown in FIG. 9 are denoted by the same reference numerals. Inertial force sensor 511 of the

Comparative Example includes fault diagnostic wiring 210 instead of fault diagnostic wiring 219 shown in FIG. 9. One end of fault diagnostic wiring 210 is connected to fault diagnostic electrode 218. Another end of fault diagnostic wiring 210 is branched into two branch lines. One of the branch lines is connected to plummet-displacement electrode 216 through beam 214a while the other branch line is connected to plummet-displacement electrode 216 through beam 214b. In this configuration, for example, even if inertial force sensor 511 is in a fault state in which one of beams 214a is broken due to, e.g. drop or shock, since beam 214b is connected, fault diagnostic wiring 210 provided at beam 214b is not disconnected. Therefore, although beam 214a is broken, inertial force sensor 511 cannot detect the fault by the self-diagnostic function.

In inertial force sensor 211 in accordance with Embodiment 3, as shown in FIGS. 11A and 11B, when one of beams 214a and 214b is broken, voltage Vd is not applied between plummet-displacement electrode 216 and counter electrode 217. Therefore, plummet 213 is not displaced, resistances of strain-sensitive resistors R201 and R204 are not changed, so that it can be determined that inertial force sensor 211 is in a fault state.

### Exemplary Embodiment 4

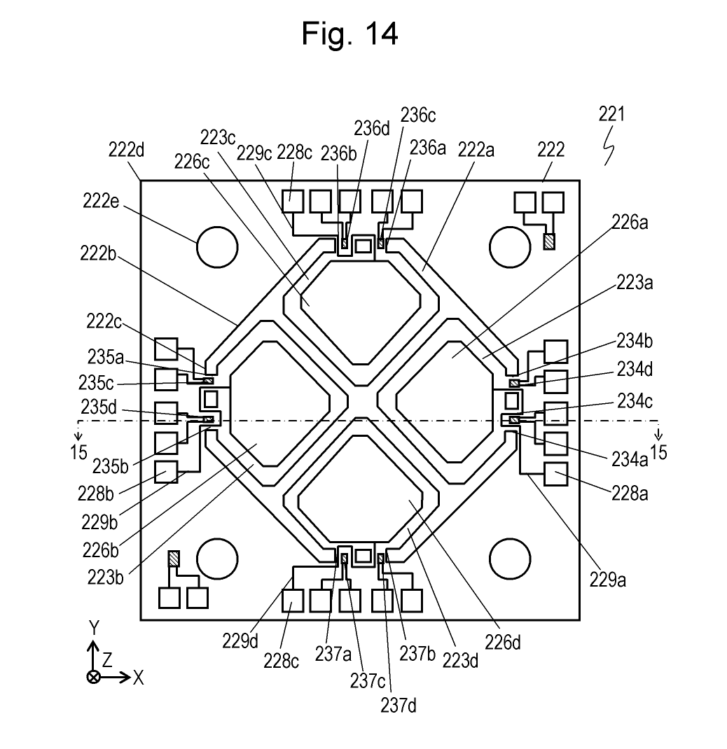

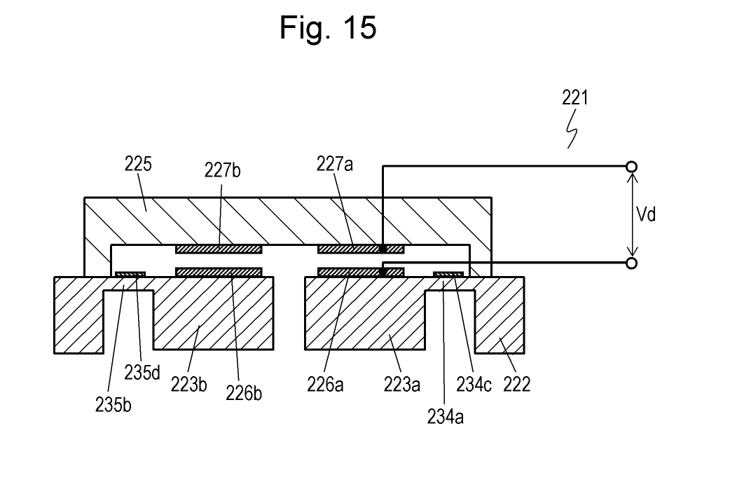

FIG. 14 is a top view of inertial force sensor 221 in accordance with Exemplary Embodiment 4. FIG. 15 is a sectional view of inertial force sensor 221 at line 15-15 shown in FIG. 14.

Inertial force sensor 221 includes fixed part 222 having a frame shape, beams 234a to 237a and 234b to 237b having respective one ends connected to fixed part 222, plummets 223a to 223d, counter substrate 225 coupled to fixed part 222 such that counter substrate 225 faces upper surfaces of plummets 223a to 223d, plummet-displacement electrodes 226a to 226d provided on upper surfaces of plummets 223a to 223d, respectively, counter electrodes 227a to 227d provided on a lower surface of counter substrate 225, fault diagnostic electrodes 228a to 228d provided at fixed part 222, and fault diagnostic wirings 229a to 229d for electrically connecting fault diagnostic electrodes 228a to 228d to plummet-displacement electrodes 226a to 226d, respectively. The lower surfaces of counter electrodes 227a to 227d face the upper surfaces of plummet-displacement electrodes 226a to 226d, respectively. Detection units 234c to 237c and 234d to 237d are provided on the upper surfaces of beams 234a to 237a and 234b to 237b, respectively.

Fault diagnostic wirings 229a to 229d are connected to fault diagnostic electrodes 228a to 228d, respectively. Fault diagnostic wiring 229a extends from fault diagnostic electrode 228a through beams 234a and 234b to be connected to plummet-displacement electrode 226a. Fault diagnostic wiring 229b extends from fault diagnostic electrode 228b through beams 235a and 235b to be connected to plummet-displacement electrode 226b. Fault diagnostic wiring 229c extends from fault diagnostic electrode 228c through beams 236a and 236b to be connected to plummet-displacement electrode 226c. Fault diagnostic wiring 229d extends from fault diagnostic electrode 228d through beams 237a and 237b to be connected to plummet-displacement electrode 226d.

In this configuration, voltage Vd is applied between plummet-displacement electrodes 226a to 226d and counter electrodes 227a to 227d to apply electrostatic forces to plummets 223a to 223d to displace plummets 223a to 223d as if acceleration is applied to plummets 223a to 223d, thus providing a self-diagnostic function for determining whether inertial force sensor 211 normally operates or not.

A configuration of inertial force sensor 221 will be detailed below.

Fixed part 222 has a rectangular frame shape having hollow region 222a at the center thereof viewing from above. Hollow region 222a may have a rectangular shape or a circular shape.

As shown in FIG. 14, the outer edge of hollow region 222a has an octagon shape having four longer sides 222b and four shorter sides 222c located alternately. Four longer sides 222b may preferably face four corner portions 222d of fixed part 222. This configuration allows adhesive region 222e for adhesively bonding counter substrate 225 to fixed part 222 to be located in a region between each of four longer sides 222b and respective one of corner portions 222d. This configuration allows an area of counter substrate 225 to be smaller than an area of fixed part 222. The small area of counter substrate 225 can expose an end portion of fixed part 222 from counter substrate 225, and allows fault diagnostic electrode 228 to be provided at the end portion of fixed part 222 and to be coupled to a package or an IC easily.

Beams 234a to 237a and 234b to 237b are preferably connected to four shorter sides 222c of hollow region 222a. This configuration reduces the lengths of wirings between fault diagnostic electrodes 228a to 228d and detection units 234c to 237c and 234d to 237d provided at the end portion of fixed part 222, accordingly preventing unnecessary noises from being mixed. Examples of a method for adhesively bonding fixed part 222 to counter substrate 225 include adhesively bonding with adhesives, metal junction, ambient temperature junction, and anode junction. Adhesives, such as epoxy resin and silicone resin, can be used. When the adhesives are heated to be hardened in the manufacturing process, since a stress is generated due to the hardening of adhesives and a difference of linear expansion coefficients of fixed part 222 and counter substrate 225, this stress is accumulated in beams 234a to 237a and 234b to 237b as residual stress. In inertial force sensor 221 in accordance with Embodiment 4, since plummets 223a to 223d are supported by beams 234a to 237a and 234b to 237b from only one direction, it is possible to suppress transition of beams 234a to 237a and 234b to 237b to different buckling modes. Silicone resin as adhesives can reduce the stress due to the hardening of the adhesive.

As shown in FIG. 14, beams 234a to 237a and 234b to 237b having one end connected to fixed part 222 extend to hollow region 222a. A thickness of each of beams 234a to 237a and 234b to 237b is preferably smaller than a thickness of fixed part 222, and smaller than a thickness of each of plummets 223a to 223d. This configuration allows beams 234a to 237a and 234b to 237b to easily warp, and increases sensitivity of inertial force sensor 221 to the acceleration. Plummet 223a is connected to respective another ends of beams 234a and 234b. Plummet 223b is connected to respective another ends of beams 235a and 235b. Plummet 223c is connected to respective another ends of beams 236a and 236b. Plummet 223d is connected to respective another ends of beams 237a and 237b. Each of plummets 223a to 223d has a projection. The projection of plummet 223a faces the projection of plummet 223b while the projection of plummet 223c faces the projection of plummet 223d. That is, the projections of plummets 223a to 223d preferably face each other across the center of hollow region 222a. This configuration locates four plummets 223a to 223d close to each other. This arrangement increases the weights of four plummets 223a to 223d as to increase the sensitivity of inertial force sensor 221 and decrease the size of inertial force sensor 221.

Fixed part 222, beams 234a to 237a and 234b to 237b, plummets 223a to 223d, and counter substrate 225 may be made of, e.g. silicon, molten quartz, or alumina. They are preferably made of silicon to provide inertial force sensor 221 with a small size by using micromachining technology.

Detection units 234c to 237c and 234d to 237d can utilize, e.g. a strain resistance method or a capacitance method. When piezoelectric resistors are used for the strain resistance method, the sensitivity of inertial force sensor 221 can be improved. As the strain resistance method, a thin film resistance method employing oxide film strain-sensitive resistors improves temperature characteristics of inertial force sensor 221.

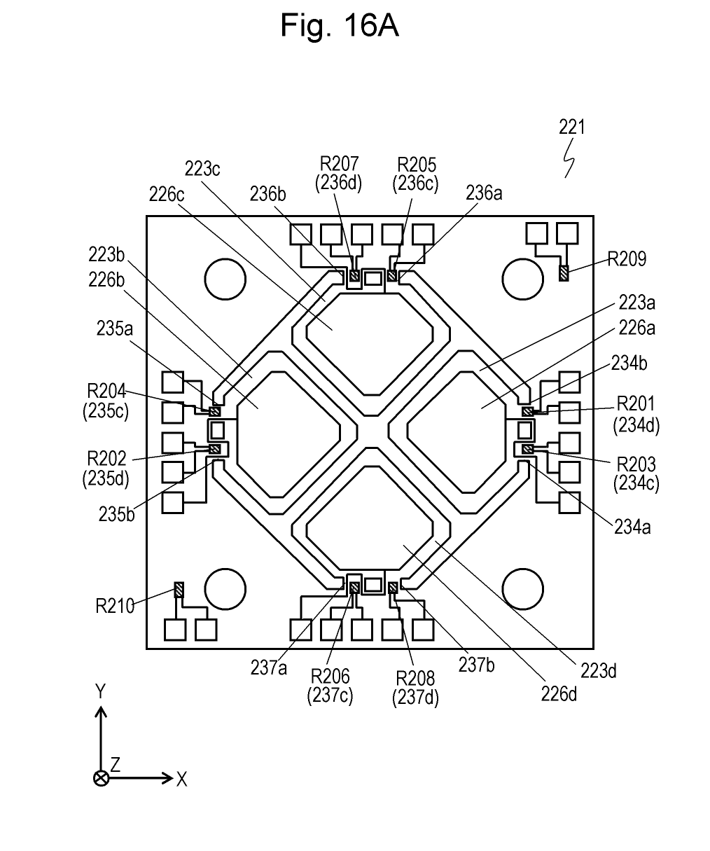

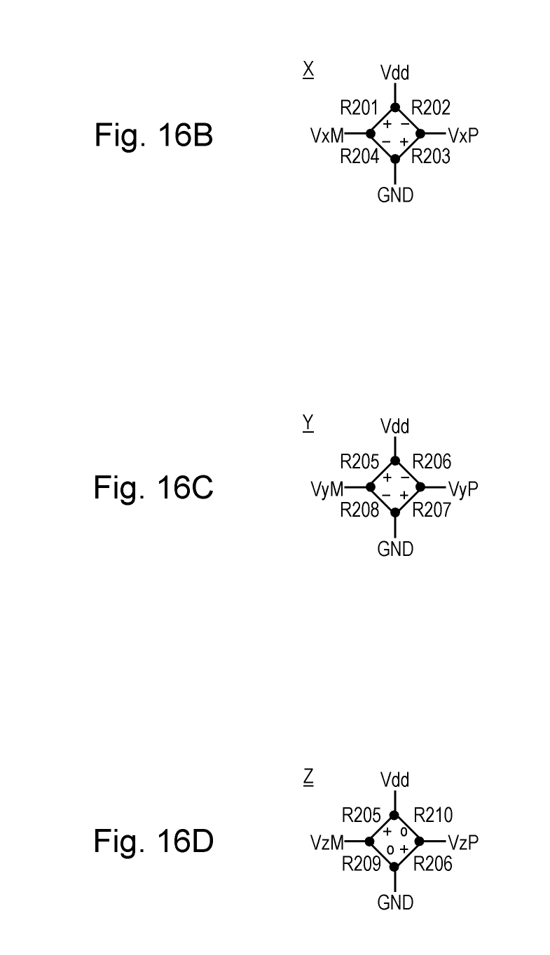

FIG. 16A is a top view of inertial force sensor 221 for illustrating a method for detecting acceleration. Strain-sensitive resistors R203 and R201 are disposed as detection units 234c and 234d provided on the upper surfaces of beams 234a and 234b, respectively. Strain-sensitive resistors R204 and R202 are disposed as detection units 235c and 235d provided on the upper surfaces of beams 235a and 235b, respectively. Strain-sensitive resistors R205 and R207 are disposed as detection units 236c and 236d provided on the upper surfaces of beams 236a and 236b, respectively. Strain-sensitive resistors R206 and R208 are disposed as detection units 237c and 237d provided on the upper surfaces of beams 237a and 237b, respectively. Strain-sensitive resistors R209 and R210 are disposed on fixed part 222.

FIG. 16B is a circuit diagram of an X-axis detection circuit of inertial force sensor 221 for detecting acceleration in a direction of the X-axis. Strain-sensitive resistors R201, R202, R203, and R204 are connected to form a bridge circuit. While a voltage is applied between a pair of nodes Vdd and GND opposite to each other, potential difference Vsx between another pair of nodes VxP and VxM (a difference obtained by subtracting a voltage at node VxM from a voltage at node VxP) is detected, thereby detecting the acceleration in the direction of the X-axis.

FIG. 16C is a circuit diagram of a Y-axis detection circuit of inertial force sensor 221 for detecting acceleration in a direction of the Y-axis. Strain-sensitive resistors R205, R206, R207, and R208 are connected to form a bridge circuit. While a voltage is applied between a pair of nodes Vdd and GND opposite to each other, potential difference Vsy between another pair of nodes VyP and VyM (a difference obtained by subtracting a voltage at node VyM from a voltage at node VyP) is detected, thereby detecting the acceleration in the direction of the Y-axis.

FIG. 16D is a circuit diagram of a Z-axis detection circuit of inertial force sensor 221 for detecting acceleration in a direction of the Z-axis. Strain-sensitive resistors R205, R210, R206, and R209 are connected to form a bridge circuit. While a voltage is applied between a pair of nodes Vdd and GND opposite to each other, potential difference Vsz between the other pair of nodes VzP and VzM (a difference obtained by subtracting a voltage at node VzM from a voltage at node VzP) is detected, thereby detecting the acceleration in the direction of the Z-axis.

Next, a self-diagnostic function of inertial force sensor 221 in accordance with Embodiment 4 will be described. Inertial force sensor 221 in accordance with Embodiment 4 preforms the self-diagnosis with three voltage-applying patterns 1 to 3.

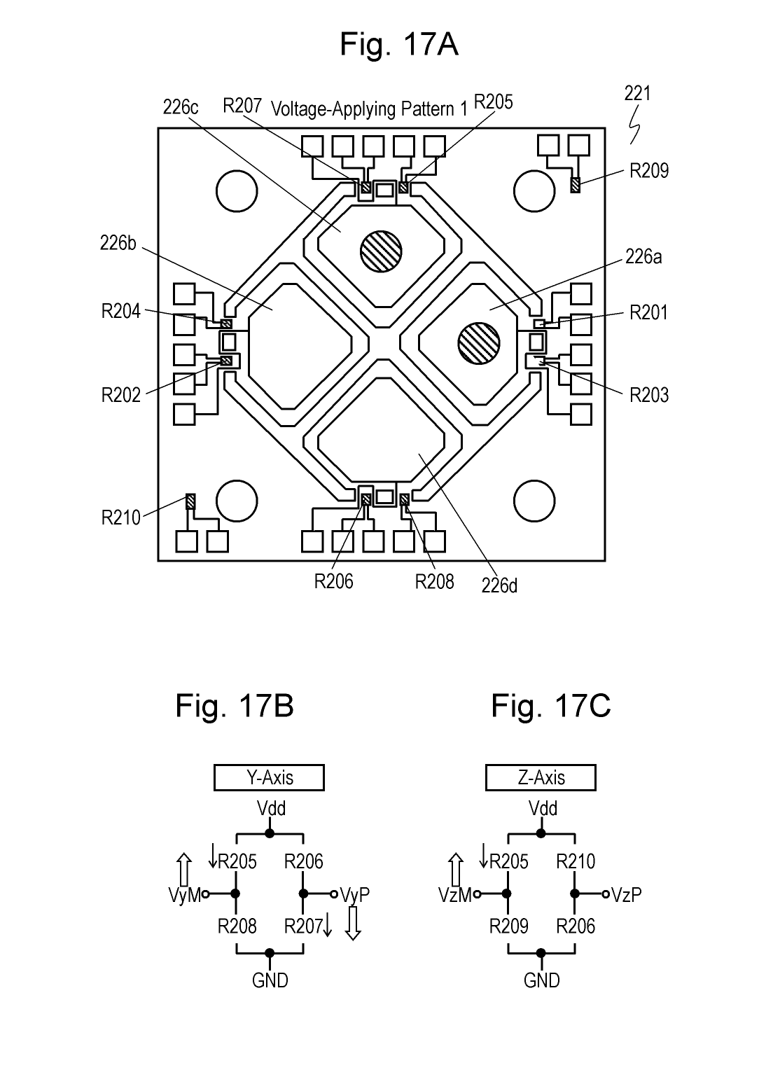

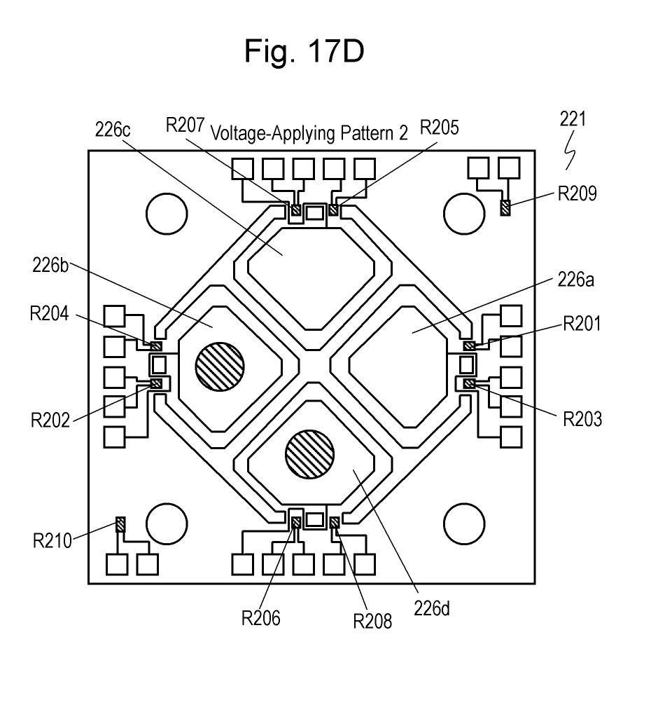

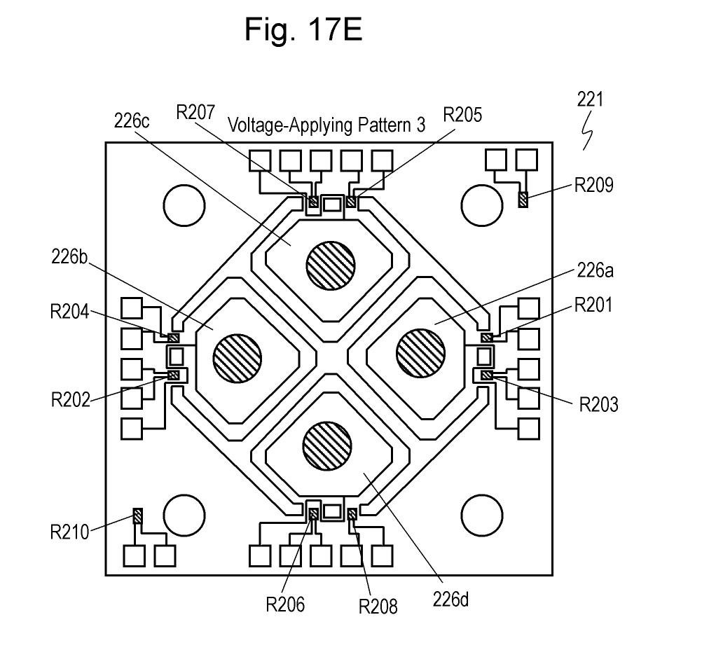

FIG. 17A is a top view of inertial force sensor 221 for illustrating voltage-applying pattern 1. FIGS. 17B and 17C are circuit diagrams of inertial force sensor 221 for performing the self-diagnosis with voltage-applying pattern 1. In voltage-applying pattern 1, predetermined voltage Vd is applied between plummet-displacement electrode 226a provided on the upper surface of plummet 223a and counter electrode 227a while predetermined voltage Vd is applied between plummet-displacement electrode 226c provided on the upper surface of plummet 223c and counter electrode 227c. A voltage is not applied between plummet-displacement electrode 226b provided on the upper surface of plummet 223b and counter electrode 227b, and a voltage is not applied between plummet-displacement electrode 226d provided on the upper surface of plummet 223d and counter electrode 227d. This pattern generates an electrostatic force to displace plummets 223a and 223c such that counter substrate 225 attracts plummets 223a and 223c, but not to displace plummets 223b and 223d. The displacement of plummets 223a and 223d decreases resistances of strain-sensitive resistors R201, R203, R205, and R207. As shown in FIG. 17B, in the Y-axis detection circuit, since a voltage at node VyM increases and a voltage at node VyP decreases, potential difference Vsy between nodes VyP and VyM (a difference obtained by subtracting a voltage at node VyM from a voltage at node VyP) is a negative value. Furthermore, as shown in FIG. 17C, in the Z-axis detection, a voltage at node VzM increases, and a voltage at node VzP is not changed. Therefore, potential difference Vsz between nodes VzP and VzM (a difference obtained by subtracting a voltage at node VzM from a voltage at node VzP) is a negative value. Thus, when both potential differences Vsy and Vsx output from the Y-axis detection circuit and the Z-axis detection circuit are the negative values, it can be determined that beams 234a, 234b and 236a, 236b are not broken and the sensor operates normally.

FIG. 17D is a top view of inertial force sensor 221 showing voltage-applying pattern 2. In voltage-applying pattern 2, predetermined voltage Vd is applied between plummet-displacement electrode 226b provided on the upper surface of plummet 223b and counter electrode 227b while predetermined voltage Vd is applied between plummet-displacement electrode 226d provided on the upper surface of plummet 223d and counter electrode 227d. At this moment, a voltage is not applied between plummet-displacement electrode 226a provided on the upper surface of plummet 223a and counter electrode 227a, and voltage Vd is not applied between plummet-displacement electrode 226c provided on the upper surface of plummet 223c and counter electrode 227c. This pattern generates an electrostatic force to displace plummets 223b and 223d such that they counter substrate 225 attracts plummets 223b and 223d, but not to displace plummets 223a and 223c. The displacement of plummets 223b and 223d decreases resistances of strain-sensitive resistors R202, R204, R206, and R208. Therefore, in the Y-axis detection circuit shown in FIG. 16c, since a voltage at node VyM decreases and a voltage at node VyP increases, potential difference Vsy between nodes VyP and VyM (a difference obtained by subtracting a voltage at node VyM from a voltage at node VyP) is a positive value. In the Z-axis detection shown in FIG. 16D, a voltage at node VzM is not changed, and a voltage at node VzP decreases. Therefore, potential difference Vsz between nodes VzP and VzM (a difference obtained by subtracting a voltage at node VzM from a voltage at node VzP) is a negative value. Thus, when potential difference Vsy output from the Y-axis detection circuit becomes the positive value and potential difference Vsz output from the Z-axis detection circuit becomes the negative value, it can be determined that beams 235a, 235b, 237a, and 237b are not broken and the sensor operates normally.

FIG. 17E is a top view of inertial force sensor 221 showing voltage-applying pattern 3. In voltage-applying pattern 3, predetermined voltage Vd is applied between plummet-displacement electrodes 226a to 226d provided on the upper surfaces of plummets 223a to 223d and counter electrodes 227a to 227d. This operation generates an electrostatic force to displace plummets 223a to 223d such that counter substrate 225 attracts plummets 223a to 223d. The displacements of plummets 223a to 223d decrease resistances of strain-sensitive resistors R201 to R208. Therefore, in the Y-axis detection circuit shown in FIG. 16C, voltages at nodes VyM and VyP are not changed, potential difference Vsy between nodes VyP and VyM (a difference obtained by subtracting a voltage at node VyM from a voltage at node VyP) becomes zero. In the Z-axis detection circuit shown in FIG. 16D, since a voltage at node VzM increases and a voltage at VzP decreases, potential difference Vsz between the pair of the other nodes VzP and VzM (a difference obtained by subtracting a voltage at node VzM from a voltage at node VzP) is a negative value. Thus, when potential difference Vsy output from the Y-axis detection circuit becomes zero, and potential difference Vzx output from the Z-axis detection becomes the negative value, it can be determined that beams 234a to 237a and 234b to 237b are not broken and inertial force sensor 221 operates normally.

If any beam of beams 234a to 234a and 234b to 237b connected to plummets 223a to 223d is broken, the plummet connected to the broken beam is not displaced, and it can be determined by the above self-diagnostic function that an operation is in a fault state.

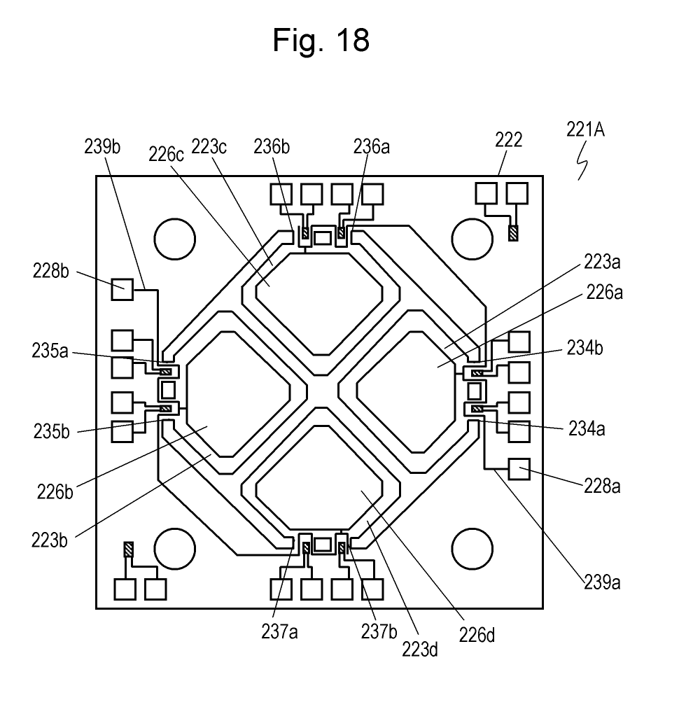

FIG. 18 is a top view of another inertial force sensor 221A in accordance with Embodiment 4. In FIG. 18, components identical to those of inertial force sensor 221 shown in FIG. 14 are denoted by the same reference numerals. In inertial force sensor 221 shown in FIG. 14, four fault diagnostic wirings 229a to 229d connected to plummet-displacement electrodes 226a to 226d on the upper surfaces of plummets 223a to 223d are connected to other fault diagnostic electrodes 228a to 228b, respectively. Inertial force sensor 221A shown in FIG. 18 does not include fault diagnostic electrodes 228c and 228d, and includes fault diagnostic wirings 239a and 239b connected to fault diagnostic electrodes 228a and 228b, respectively, instead of fault diagnostic wiring 229a to 229d. Fault diagnostic wiring 239a extends from fault diagnostic electrode 228a through beams 234a and 234b to be connected to plummet-displacement electrode 226a on the upper surface of plummet 223a. Fault diagnostic wiring 239a further extends from plummet-displacement electrode 226a through beams 236a and 236b to be connected to plummet-displacement electrode 226c on the upper surface of plummet 223c. Fault diagnostic wiring 239b extends from fault diagnostic electrode 228b through beams 235a and 235b to be connected to plummet-displacement electrode 226b on the upper surface of plummet 223b. Fault diagnostic wiring 239b further extends from plummet-displacement electrode 226b through beams 237a and 237b to be connected to plummet-displacement electrode 226d on the upper surface of plummet 223d. Inertial force sensor 221A can perform a self-diagnosis with voltage-applying patterns 1 to 3 shown in FIGS. 17A to 17E. The smaller number of the fault diagnostic electrodes reduces the size of inertial force sensor 221A. The smaller number of the fault diagnostic electrodes reduces the number of bonding wires between the fault diagnostic electrode and a mount board having inertial force sensor 221A mounted thereto, hence simplifying the manufacturing process.

Inertial force sensors 211, 221, and 221A in accordance with the embodiments are acceleration sensors for detecting acceleration, but may be different types of sensors, such as strain sensors.

In the above exemplary embodiments, terms, such as “upper surface” and “lower surface”, indicating directions merely indicate relative directions dependent only on the relative positional relation of components, such as plummets of inertial force sensors, but do not indicate absolute directions, such as a vertical direction.

As mentioned above, inertial force sensors 211, 221, and 221A in accordance with Embodiments 3 and 4 can diagnose fault by the self-diagnostic function even when only one beam is broken due to shock or the like and the other beam is not broken, thus having high reliability.

Therefore, the inertial force sensors are useful as sensors, such as an inertial force sensor and an angular velocity sensor, which are used for, e.g. vehicles, navigation devices, and portable terminals.

### INDUSTRIAL APPLICABILITY

An inertial force sensor according to the present invention has high reliability, and is useful as an inertial force sensor used for, e.g. vehicles and portable terminals.

### REFERENCE MARKS IN THE DRAWINGS

21a Fixed Part (First Fixed Part)

21b Fixed Part (Second Fixed Part)

23a Beam (First Beam)

24a Beam (Second Beam)

27 Plummet (First Plummet)

27a Conductive Part (First Conductive Part)

28 Plummet (Second Plummet)

28a Conductive Part (First Conductive Part)

31a Strain-Sensitive Resistor (First Strain-Sensitive Resistor)

32a Strain-Sensitive Resistor (Second Strain-Sensitive Resistor)

39 Fault Diagnostic Electrode (First Fault Diagnostic Electrode, Third Fault Diagnostic Electrode)

40a Fault Diagnostic Electrode (Second Fault Diagnostic Electrode, Fourth Fault Diagnostic Electrode)

43 Comparator (First Comparator, Second Comparator)

44 Non-Inverting Input Terminal

45 Inverting Input Terminal

48a Fault Diagnostic Wiring (Second Fault Diagnostic Wiring, Fourth Fault Diagnostic Wiring)

48c Fault Diagnostic Wiring (First Fault Diagnostic Wiring, Third Fault Diagnostic Wiring)

211, 221, 221a Inertial Force Sensor

212, 222 Fixed Part

213, 223a Plummet (First Plummet)

214a, 234a Beam (First Beam)

214b, 234b Beam (Second Beam)

216, 226a Plummet-Displacement Electrode (First Plummet-Displacement Electrode)

217, 227a Counter Electrode (First Counter Electrode)

218, 228, 228a-228d Fault Diagnostic Electrode

219, 229a-229d Fault Diagnostic Wiring

223c Plummet (Second Plummet)

226c Plummet-Displacement Electrode (Second Plummet-Displacement Electrode)

227c Counter Electrode (Second Counter Electrode)

236a Beam (Third Beam)

236b Beam (Fourth Beam)

1-10. (canceled)

11. An inertial force sensor configured to detect an inertial force applied thereto, comprising:
a first fixed part;
a first beam having one end and another end, the one end of the first beam being connected to the first fixed part;
a first plummet connected to the another end of the first beam, the first plummet being displaceable due to the inertial force to cause the first beam to deform;
a first conductive part provided at the first plummet;
a first strain-sensitive resistor provided at the first beam, for detecting a deformation of the first beam
a first fault diagnostic electrode provided at the first fixed part;
a second fault diagnostic electrode provided at the first fixed part;
a first fault diagnostic wiring for connecting the first fault diagnostic electrode to the first conductive part through the first beam; and
a second fault diagnostic wiring for connecting the second fault diagnostic electrode to the first conductive part through the first beam,
wherein the first fault diagnostic electrode is configured to be connected to a non-inverting input terminal of a comparator to have a voltage applied to the first fault diagnostic electrode, and
wherein the second fault diagnostic electrode is configured to be connected to an inverting input terminal of the comparator.

12. The inertial force sensor according to claim 11, further comprising:
a second fixed part;
a second beam having one end and another end, the one end of the second beam being connected to the second fixed part;
a second plummet connected to the another end of the second beam, the second plummet being displaceable due to the inertial force to cause the second beam to deform;
a second conductive part provided at the second plummet;
a second strain-sensitive resistor provided at the second beam, for detecting a deformation of the second beam;
a third fault diagnostic electrode provided at the second fixed part;
a fourth fault diagnostic electrode provided at the second fixed part;
a third fault diagnostic wiring for connecting the third fault diagnostic electrode to the second conductive part through the second beam; and
a fourth fault diagnostic wiring for connecting the fourth diagnostic electrode to the second conductive part through the second beam.

13. The inertial force sensor according to claim 12,
wherein the third fault diagnostic electrode is configured to be connected to a non-inverting input terminal of a second comparator to have a voltage applied to the third fault diagnostic electrode, and
wherein the fourth fault diagnostic electrode is configured to be connected to an inverting input terminal of the second comparator.

14. An inertial force sensor for detecting an inertial force applied thereto, comprising:
a first fixed part;
a first beam having one end and another end, the one end of the first beam being connected to the first fixed part;
a first plummet connected to the another end of the first beam, the first plummet being displaceable due to the inertial force to cause the first beam to deform;
a first conductive part provided at the first plummet;
a first strain-sensitive resistor provided at the first beam, for detecting a deformation of the first beam;
a second fixed part;
a second beam having one end and another end, the one end of the second beam being connected to the second fixed part;
a second plummet connected to the another end of the second beam, the second plummet being displaceable due to the inertial force to cause a deformation of the second beam;
a second conductive part provided at the second plummet;
a second strain-sensitive resistor provided at the second beam, for detecting a deformation of the second beam;
a first fault diagnostic electrode provided at the first fixed part;
a second fault diagnostic electrode provided at one of the first fixed part and the second fixed part; and
a plurality of fault diagnostic wirings for connecting the first conductive part and the second conductive part in series between the first fault diagnostic electrode and the second fault diagnostic electrode through the first beam and the second beam.

15. The inertial force sensor according to claim 14,
wherein the first fault diagnostic electrode is configured to be connected to a non-inverting input terminal of a comparator to have a voltage applied to the first fault diagnostic electrode, and
wherein the second fault diagnostic electrode is configured to be connected to an inverting input terminal of the comparator.

16. An inertial force sensor for detecting an inertial force applied thereto, comprising:
a fixed part;
a first beam having one end and another end, the one end of the first beam being connected to the fixed part;
a second beam having one end and another end, the one end of the second beam being connected to the fixed part;
a first plummet connected to the another end of the first beam and the another end of the second beam, the first plummet being displaceable due to the inertial force to cause the first beam and the second beam to deform;
a first plummet-displacement electrode provided at the first plummet;
a first counter electrode facing the first plummet-displacement electrode with a predetermined space between the first counter electrode facing the first plummet-displacement electrode;
a fault diagnostic electrode provided at the fixed part; and
a first fault diagnostic wiring extending from the fault diagnostic electrode and connected to the first plummet-displacement electrode through the first beam and the second beam.

17. The inertial force sensor according to claim 16, wherein the first fault diagnostic wiring passes through the one end and the another end of the first beam and the one end and the another end of the second beam.

18. The inertial force sensor according to claim 17, further comprising:
a third beam having one end and another end, the one end of the third beam being connected to the fixed part;
a fourth beam having one end and another end, the one end of the fourth beam being connected to the fixed part;
a second plummet connected to the another end of the third beam and the another end of the fourth beam;
a second plummet-displacement electrode provided on an upper surface of the second plummet;
a second counter electrode facing the second plummet-displacement electrode with a predetermined space between the second counter electrode facing the second plummet-displacement electrode; and
a second fault diagnostic wiring for electrically connecting the fault diagnostic electrode to the second plummet-displacement electrode through the third beam and the fourth beam.

19. The inertial force sensor according to claim 18, wherein the second fault diagnostic wiring passes through the one end and the another end of the third beam and the one end and the another end of the fourth beam.

20. The inertial force sensor according to claim 16, further comprising:
a third beam having one end and another end, the one end of the third beam being connected to the fixed part;
a fourth beam having one end and another end, the one end of the fourth beam being connected to the fixed part;
a second plummet connected to the another end of the third beam and the another end of the fourth beam;
a second plummet-displacement electrode provided on an upper surface of the second plummet;
a second counter electrode facing the second plummet-displacement electrode with a predetermined space between the second counter electrode facing the second plummet-displacement electrode; and
a second fault diagnostic wiring for electrically connecting the fault diagnostic electrode to the second plummet-displacement electrode through the third beam and the fourth beam.

21. The inertial force sensor according to claim 20, wherein the second fault diagnostic wiring passes through the one end and the another end of the third beam and the one end and the another end of the fourth beam.
